(19) United States
(12) Patent Application Publication
(10) Pub. No.: US 2005/0276953 A1
(43) Pub. Date: Dec. 15, 2005

(54) Selective adhesive gift wrapping sheet

(75) Inventors: Jonathan P. Kitchin, Austin, TX (US); Manisha Sarkar, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/868,264

(22) Filed: Jun. 14, 2004

(51) Int. Cl. B65D 65/38; B32B 3/00

(52) U.S. Cl. 428/195.1; 229/87.19

(57) ABSTRACT

The disclosure is a gift wrap material affixable to a target surface. The gift wrap material comprises a linerless opaque first substrate. The first substrate has a first major surface and a second major surface. A selective adhesion mechanism is disposed on the first major surface. The selective adhesion mechanism includes a pressure sensitive adhesive and is configured so as to provide a first adhesion force to the target surface before activation of the mechanism and a second adhesion force to the substrate after activation of the mechanism. The first adhesion force is at a level so as to allow the sheet to be positionable on the target surface. The invention also is a method for wrapping a gift. A linerless opaque first substrate is provided. The substrate has a first major surface, a second major surface and a selective adhesion mechanism disposed on the first major surface. The first major surface is positioned against the gift with substantially no adhesion of the first substrate to the gift. The selective adhesion mechanism is activated by applying a force to the second major surface. The first substrate is adhered to the gift.

### BACKGROUND OF THE INVENTION

The disclosure relates generally to gift wrapping sheets that are readily positionable, by sliding contact, over an object to be wrapped, until the sheet is activated by selective application of pressure whereupon an adhesive bond is formed.

Many types of decorative sheet materials are available for wrapping gifts and similar packages. Sheets of patterned paper or plastic foil are commonly used for this purpose and are usually secured in place using adhesive tape. Some dexterity is needed to hold the wrapping paper in place while applying adhesive tape to secure the sheet tightly in the desired position. In recognition of this problem, self-stick wrapping sheets that are pre-treated with adhesive have been proposed as an alternative. However, available self-stick sheets suffer from significant limitations that have prevented their widespread acceptance as gift wrapping materials. Manipulation of a large, thin, adhesive-backed sheet easily leads to the sheet adhering prematurely in the wrong position or folding over and adhering to itself. Sheets that are pretreated with “repositionable” adhesive offer only limited improvement in this regard, since premature contact still leads to instant bonding, albeit at a level that allows removal.

So called “pressure sensitive adhesives” (PSAs) are adhesives that are permanently tacky and adhere on contact. As they are conventionally used, PSAs do not allow for sliding contact with the target surface, but must be positioned above the surface, in the correct position, prior to contact. Repositionable PSAs, for example microsphere adhesives, similarly do not allow for sliding contact with a target surface.

Discontinuous, or pattern-coated, adhesive backed sheets likewise offer little benefit other than to facilitate removal of the sheet if it becomes adhered in the wrong position. Adhesive-backed wrapping sheets may be laminated to a peelable release liner that prevents contact with the adhesive until the liner is removed and discarded. However, the use of a release liner adds cost to the product, and only facilitates handling of the sheet up to the point when the liner is removed.

Thus there remains a need for gift wrapping material that may be positioned by sliding contact over the object that is to be wrapped and, once in position, forming an adhesive bond by a simple activation mechanism. Several types of activatable adhesives are known, for example, water-activated or heat-activated adhesives. However, neither of these activation mechanisms offers the benefits of ease and convenience desirable in gift wrapping applications since an additional step requiring wetting the adhesive or applying a heat source to the adhesive is required. This step requires additional tools or devices (i.e., a sponge or a hair dryer) to activate the adhesive, and also increases the potential for damage to the package. It would be desirable to provide an improved gift wrap material, which is easily handled and manipulated by a user during the wrapping process, which forms an adequate adhesive bond with the object to effectively secure the gift wrap material to the object without the use of additional tools or fasteners. It would further be desirable to provide such gift wrap material, which is capable of being readily manufactured and stored.

### SUMMARY OF THE INVENTION

The disclosure is a gift wrap material affixable to a target surface. The gift wrap material comprises a linerless opaque first substrate. The first substrate has a first major surface and a second major surface. A selective adhesion mechanism is disposed on the first major surface. The selective adhesion mechanism includes a pressure sensitive adhesive and is configured so as to provide a first adhesion force to the target surface before activation of the mechanism and a second adhesion force to the substrate after activation of the mechanism. The first adhesion force is at a level so as to allow the sheet to be positionable on the target surface. The disclosure also is a method for wrapping a gift. A linerless opaque first substrate is provided. The substrate has a first major surface, a second major surface and a selective adhesion mechanism disposed on the first major surface. The first major surface is positioned against the gift with substantially no adhesion of the first substrate to the gift. The selective adhesion mechanism is activated by applying a force to the second major surface. The first substrate is adhered to the gift.

### BRIEF DESCRIPTION OF THE DRAWINGS

The present invention will be further explained with reference to the drawing figures referenced below, wherein like structure is referred to by like numerals throughout the several views.

FIG. 1 is an isometric view of the inventive gift wrap material disposed about a shaped object.

FIG. 2 is a partial cross-sectional view of one embodiment of the inventive gift wrap material.

FIG. 2A is a partial cross-sectional view of the embodiment of the gift wrap material illustrated in FIG. 2, with the gift wrap material partially adhered to a target surface.

FIG. 3 is a partial cross-sectional view of a second embodiment of the inventive gift wrap material.

FIG. 3A is a partial cross-sectional view of a third embodiment of the inventive gift wrap material.

FIG. 4 is a partial cross-sectional view of a fourth embodiment of the inventive gift wrap material.

FIG. 4A is a partial top view of the embodiment of the gift wrap material illustrated in FIG. 4.

While the above-identified drawings set forth several embodiments, other embodiments of the present disclosure are also contemplated, as noted in the discussion. This disclosure presents illustrative embodiments of the present invention by the way of representation and not limitation. The drawings are not drawn to scale and are for illustrative purposes. Numerous other modifications and embodiments can be devised by those skilled in the art which fall within the spirit and scope of the principles of this invention.

### DETAILED DESCRIPTION OF THE INVENTION

The inventive gift wrap material is shown in FIG. 1 at 10. The gift wrap material 10 is illustrated, partially wrapped around a shaped object 12 in a typical fashion used for wrapping gifts. An inner surface 14 of gift wrap material 10 is disposed against object 12 and decorative surface 16 is disposed so as to be visible. While graphics (or indicia) 17 are illustrated on decorative surface 16, it should be understood that any surface decoration (or no decoration at all) is included within the scope of the invention. In some embodiments, the gift wrap material 10 is substantially opaque. In general, the level of opacity should be such that the object 12 wrapped is obscured from view. In other embodiments, the gift wrap material can be completely opaque.

Inner surface 14 is provided with selective adhesion mechanism 18. Selective adhesion mechanism 18 allows a user to secure a portion of inner surface 14 to target surface 19. The underlying surface to which gift wrap material 10 is secured can be referred to generally as “target surface” throughout this application. For example, target surface 19 may be object 12 itself, or may be decorative surface 16 (if inner surface 14 overlaps decorative surface 16, as illustrated in FIG. 1). By activating a portion of the inner surface 14, the user can adhere the gift wrap material 10 in place on target surface 19, eliminating the need to use tape or any other securing mechanism.

“Activating” the selective adhesion mechanism 18 occurs by applying a force to the decorative surface (e.g., with the user's hand) that brings inner surface 14 into contact with target surface 19 until a certain predetermined level of pressure is achieved. Once this level of pressure is reached, adhesive is forced to come into contact with target surface 19, providing an adhesive force between the gift wrap material 10 and the target surface 19. The selective adhesion mechanism 18 is thereby “activated.” It should be noted that selective adhesion mechanism 18 may be disposed in discrete locations across inner surface 14 of gift wrap material 10, or alternatively may extend substantially continuously across entire inner surface 14 of gift wrap material 10. In an exemplary embodiment, it is preferable that selective adhesion mechanism 18 “activate” in a localized region with respect to where the pressure is applied by the user.

In order to resist normal handling, without premature activation, selective adhesion mechanism 18 preferably requires a predetermined level of force (pressure) in a generally normal direction to the plane of the gift wrap material of greater than about 20,000 N/m², and more preferably greater than about 50,000 N/m², to cause selective adhesion mechanism 18 to “activate.” It also allows the gift wrap material to be positioned in a roll (i.e., rolled onto a tubular core for transportation, storage, etc.) without adhering to itself.

The following procedure is useful to determine the level of pre-determined force necessary to activate the selective adhesion mechanism. Polyethylene terephthalate film is used as a standard target surface. A 15 cm by 2.5 cm strip of pure polyethylene terephthalate film (having no slip agents or surface treatment) is placed on a flat surface. A 15 cm by 2.5 cm test strip of the gift wrap material is applied to the polyethylene terephthalate film so that the selective adhesion mechanism of the gift wrap contacts the polyethylene terephthalate surface. A flat 15 cm by 2.5 cm flat glass plate is overlaid on the gift wrap material. Weights are placed on the glass plate. The weight value provides a known test pressure exerted on the selective adhesion mechanism. Pressure is applied, in this way to the test strip of gift wrap material for 15 seconds. The glass plate and weights are removed and the sample of gift wrap material is inspected to verify a detectible level of adhesion to the target surface which does not easily allow sliding of the gift wrap material with respect to the target surface.

Inner surface 14 of gift wrap material 10 is able to be slid over the surface of target surface 19 without adhering to target surface 19. Thus, selective adhesion mechanism 18 allows gift wrap material 10 to be “positionable.” In some embodiments, selective adhesion mechanism 18 has a first adhesion force level (or peel force) of less than 2 grams per centimeter when measured at a 90 degree peel angle and a peel rate of 30 cm/minute to object 12 before “activation,” making gift wrap material “positionable.” Adhesion force level (or peel force) refers to the load in grams required to peel a test strip of the gift wrap material from a target surface at the specified peel rate divided by the width of the strip, at the line of peel, in centimeters.

The following procedure is useful to determine the level of peel force of the gift wrap material to a target surface. Polyethylene terephthalate film is used as a standard target surface. A 15 cm by 2.5 cm strip of pure polyethylene terephthalate film (having no slip agents or surface treatment) is placed on a flat surface. A 15 cm by 2.5 cm test strip of the gift wrap material is applied to the polyethylene terephthalate film so that the selective adhesion mechanism of the gift wrap contacts the polyethylene terephthalate surface. A flat 15 cm by 2.5 cm flat glass plate is overlaid on the gift wrap material. Weight totaling 7.65 Kg (when combined with the weight of the plate) is placed on the glass plate. Pressure is applied, in this way to the test strip of gift wrap material for 15 seconds. The peel force required to separate the test strip of gift wrap material from the polyethylene terephthalate film is measured using an stress and stain gauge such as an Instron model 4464 device available from the Instron company of Canton Mass. A sliding stage available from ChemInstruments of Fairfield Ohio is attached to the lower jaws of the strain gauge. The underside of the polyethylene terephthalate film is attached to the sliding stage using double sided adhesive tape. One of the short edges of the gift wrap material is peeled away from the polyethylene film and attached to the upper jaws of the gauge. The strain rate is set to 30 cm per minute. The sliding stage is moved manually during peel such that a peel angle of approximately 90 degrees is maintained during peel. The average load required to peel the gift wrap strip is measured and divided by 2.5 to define the peel force in gram per cm width of peel width.

Standard target surface 19 composition would include materials such as paper, cardboard, wood, and plastic among others. After activation of selective adhesion mechanism 18, gift wrap material 10 exhibits a second adhesion force to object 12, which is higher than the first adhesion force. In some embodiments, second adhesion force (or peel force) is at least about 20 grams per centimeter when measured at a 90 degree peel angle and a peel rate of 30 cm/minute. In other embodiments, second adhesion force is at least about 40 grams per centimeter. While adhesion between target surface 19 and gift wrap material 10 after activation of selective adhesion mechanism 18 is desirable, it should also be noted that it may be desirable in certain applications to limit the second adhesion force in order to allow gift wrap material 10 to be removed from target surface 19 without damaging target surface 19 or gift wrap material 10. Therefore, it may be desirable to limit the second adhesion force to about 100 grams per centimeter width or less.

It may also be desirable to provide “repositionable” adhesive as part of selective adhesion mechanism 18, allowing selective adhesion mechanism 18 to be “deactivated” by removing gift wrap material 10 from target surface 19 and reapplied. Exemplary repositionable adhesives would be microsphere type adhesives used on Post-it® Notes, manufactured by 3M Company, St. Paul, Minn. A common (but not necessary) characteristic of adhesives designated as “repositionable” is a particle size in the range of 10 to 100 microns and a level of crosslinking resulting in a shear modulus of less than about 3×1 Pa.

A user is able to position the gift wrap material 10 with inner surface 14 against the target surface 19 (e.g., a gift), such that the selective adhesion mechanism 18 is disposed against the target surface 19 but is still able to be slid without adhering to the target surface 19. The user can then activate the selective adhesion mechanism 18 by applying pressure to the gift wrap material, forcing it against the target surface 19, using preferably at least 20,000 N/m² of force. This activates the selective adhesion mechanism 18, causing the gift wrap material to adhere to the target surface 19 preferably to a level of at least about 20 grams per centimeter width.

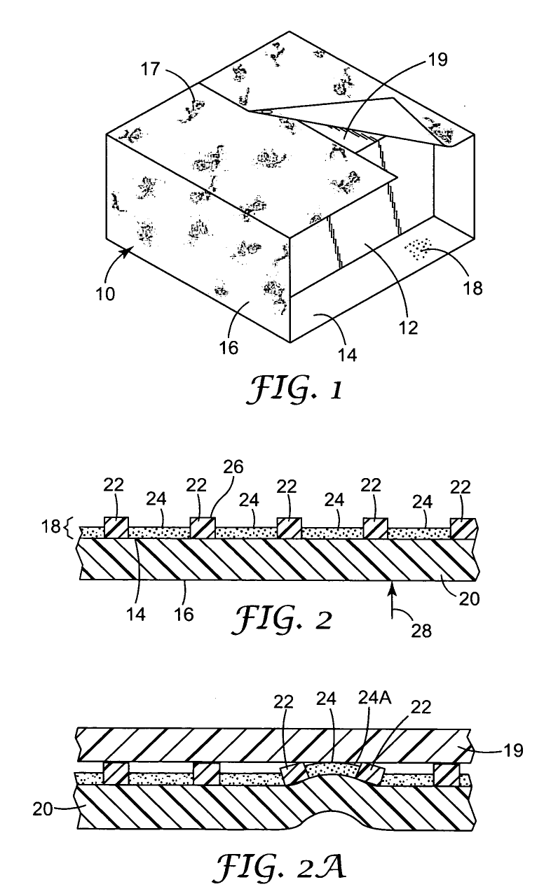

A partial cross-section of one embodiment of gift wrap material 10 is illustrated in FIG. 2. Gift wrap material 10 includes first substrate 20, decorative surface 16 formed on one major surface 20A of first substrate 20, and selective adhesion mechanism 18 disposed on the opposing major surface 20B of first substrate 20. In the illustrated embodiment, selective adhesion mechanism 18 is formed by a plurality of standoffs (or protrusions) 22 that are at least partially surrounded by adhesive 24. Preferably, the adhesive 24 is “recessed” below top surface 26 of standoffs 22, such that pressure must be applied by the user in a direction generally normal to the plane of substrate 20, as illustrated by arrow 28, in order for the adhesive to come in contact with target surface 19. For example, standoffs 22 may comprise granules of non-adhesive consistent diameter material (such as plastic or ceramic spheres), mixed into an adhesive. One exemplary overage diameter of the granules is about 100 microns. The adhesive/granule mixture is then coated on the first substrate at a specific thickness. The thickness of the coating is chosen such that the thickness of the coated adhesive is less than the average diameter of the granules. Alternatively, the adhesive may be coated on first substrate 20 at a substantially consistent thickness, and granules having an average diameter greater than that of the coating thickness applied to the adhesive (e.g, by spraying, electrostatic attraction or brushing). When the user applies the generally normal force to decorative surface 16, first substrate 20 deforms, as illustrated in FIG. 2A. The deformation of first substrate 20 pushes top surface 24A of adhesive 24 against target surface 19, adhering first substrate 20 to target surface 19 thereby “activating” the selective adhesion mechanism. One advantage of this selective adhesion configuration is that if the adhesive used is a repositionable type adhesive, the gift wrap material 10 can be removed from target surface 19, repositioned, and re-adhered, which may be desirable in certain applications. Exemplary disclosures of this general type of adhesion mechanism may be found in U.S. Pat. Nos. 4,556,595; 5,008,139 and U.S. Patent Publication No. 2003/0124291 A1, which are incorporated by reference in their entirety, herein.

In an alternate embodiment, standoffs 22 are formed from material that is under the generally normal force (arrow 28), such that the activation mechanism 18 is “activated” when standoffs 22 collapse (or break, rupture, etc.), thereby bringing the adhesive 24 into engagement with target surface 19. One advantage of this configuration of selective adhesion mechanism 18 is that the material may provide a more permanent adherence to target surface. Alternatively, standoffs 22 may deform, but retain a memory of their general original shape such that if gift wrap material 10 is removed from target surface 19, standoffs 22 return generally to their original shape, allowing the user to “reactivate” the adhesive at a later point in time. Exemplary disclosures of these general type of adhesion mechanism may be found in U.S. Pat. Nos. 3,314,838; 5,453,296; 5,965,235; and 6,254,965; which are incorporated by reference in their entirety, herein.

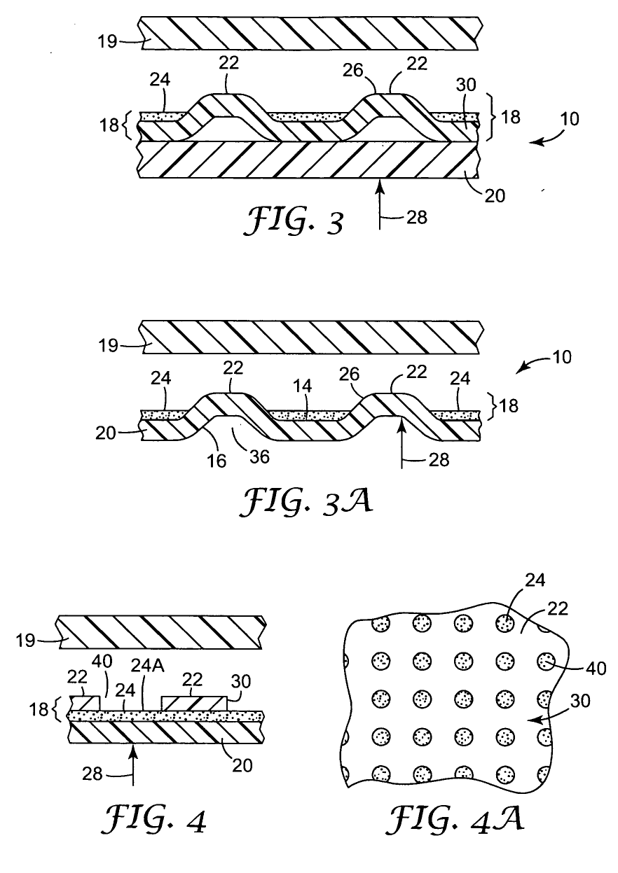

A partial cross-section of an alternate embodiment of gift wrap material 10 is illustrated in FIG. 3. While similar to the embodiment illustrated in FIG. 2, selective adhesion mechanism 18 is formed by a generally continuous second substrate 30 that is secured to first substrate 20. Second substrate 30 may be secured to first substrate 20 by a number of different methods, including lamination and coextrusion, among other methods known to a person skilled in the art. First substrate 20 and second substrate 30 may be secured together either before, or after, creation of the selective adhesion mechanism on first substrate 20. Second substrate 30 includes standoffs 22 with adhesive 24 disposed between standoffs 22. In one embodiment, standoffs extend an average of approximately 50 microns above the level of adhesive. As with the previous embodiments, adhesive 24 may either partially or completely surround standoffs 22. Thus, adhesive may be formed in discrete patches, in a continuous layer, or a combination thereof. Standoffs 22 in second substrate 30 may be formed by any number of methods known by a person skilled in the art, including embossing, vacuum forming and casting. Additionally, it should be noted that the relationship between the standoffs and the adhesive can be such that discrete portions of adhesive are surrounded by interconnected standoffs, alternatively, standoffs may be created to form ridges, with adhesive disposed between adjacent ridges, or may be formed so that individual standoffs are completely surrounded by adhesive. As discussed with respect to FIGS. 2 and 2A, by applying a generally normal force (arrow 28) to decorative surface 16 of gift wrap material, standoff 22 is fractured, deformed or “collapsed” (either with or without the ability to be “reactivated”) thereby bringing adhesive 24 into contact with target surface 19. An example of this type of selective adhesion mechanism is disclosed generally in U.S. Pat. No. 5,344,693 incorporated by reference in its entirety, herein.

An alternate embodiment of gift wrap material 10 is disclosed in FIG. 3A. In this embodiment, standoffs 22 are integrally formed into first substrate 20, with adhesive 24 being disposed on inner surface 14 of first substrate 20. The combination of standoffs 22 and adhesive 24 form selective adhesion mechanism 18. Standoffs 22 may be formed into first substrate 20 by embossing, vacuum forming, and casting or any other method known to one skilled in the art. As in the previously described embodiments, adhesive 24 is disposed between standoffs 22, and may completely surround standoffs 22, or alternatively may only partially surround standoffs 22. Top surface 26 of standoffs is substantially free of adhesive 24. If an embossing technique is used to form standoffs 22 into first substrate 20, decorative surface 16 of gift wrap material 10 may have pockets 36 formed opposite standoffs 22. Again, by applying a generally normal force (arrow 28) to decorative surface 16 of gift wrap material, standoff 22 is fractured, deformed or “collapsed” thereby bringing adhesive 24 into contact with target surface 19 (either with or without the ability to be “reactivated”).

In one embodiment, standoffs 22 are formed in a substantially amorphous pattern across inner surface 14 of gift wrap material 10. This may be particularly useful in the embodiment illustrated in FIG. 3A to resist the aligning of pockets 36 with standoffs 22 (or “nesting”) of superimposed layers such as would be encountered in a roll of gift wrap material 10. As used herein, the term “amorphous” refers to a pattern that exhibits no readily perceptible organization, regularity, or orientation of constituent elements. An advantage of the illustrated embodiment is a minimization of material layers necessary to manufacture gift wrap material 10.

It is believed that sheet materials having a pattern of standoffs, which are substantially amorphous, also exhibit “isomorphism” or are said to be “isomorphic.” For the purposes of this disclosure, isomorphic refers to substantial uniformity in geometrical and structural properties for a given circumscribed area wherever such an area is delineated within the pattern. By way of example, a prescribed area comprising a statistically significant number of standoffs with regard to the entire amorphous pattern would yield statistically substantially equivalent values for such properties as standoff area, number density of standoffs, total standoff wall length, etc. Such a correlation is believed to be desirable with respect to physical, and structural properties when uniformity is desired across the inner surface and particularly so with regard to substrate properties measured normal to the plane of the surface such as crush-resistance of protrusions, etc. It is also understood that sheet materials formed using an amorphous pattern of standoffs from material which is initially isotropic within the plane of the material remain generally isotropic with respect to physical properties in directions within the plane of the material after the amorphous pattern is imposed. As utilized herein, the term “isotropic” refers to substrate properties that are exhibited to substantially equal degrees in all directions within the plane of the substrate. The use of an amorphous pattern in a substrate is discussed in greater detail in U.S. Pat. No. 6,194,062, the disclosure of which is incorporated by reference in its entirety herein.

A partial cross-sectional view of an additional embodiment of the inventive gift wrap material 10 is illustrated in FIGS. 4 and 4A. In this embodiment, selective adhesion mechanism 18 is formed by a continuous layer of adhesive 24 disposed on first substrate 20 and second generally continuous substrate 30 disposed on top of adhesive 24. Adhesive 24 acts to bond first substrate 20 to second substrate 30. Second substrate 30 includes a plurality of openings 40 that extend through substrate 30 (best illustrated in FIG. 4A) forming standoffs 22. While openings 40 are illustrated as being organized along arrays, openings 40 may be arranged in any pattern, including in an amorphous arrangement, without departing from the scope of the disclosure. As described previously, when the user applies a force in a generally normal direction (arrow 28) to decorative surface 16, substrate 20 deforms. The deformation of substrate 20 pushes top surface 24A of adhesive 24 through one or more openings 40 and against target surface, adhering first substrate 20 to target surface 19. This type of selective adhesion mechanism is disclosed generally in U.S. Pat. No. 5,458,938, incorporated by reference in its entirety, herein.

In the embodiments illustrated in FIGS. 2, 2A, 3, 4 and 4A, the first substrate 20 is preferably comprised of paper. It should be understood that the paper substrate may include various layers (not shown) such as resin, ink, colorant, opacifier or varnish coatings which are commonly found on gift wrapping paper. While paper is the preferred substrate, it is understood that other materials may be used for the first substrate 20. Such other materials include, but are not limited to synthetic papers made from polyethylene or polypropylene and plastic films such as polyester, cellulose ester, cellulose ether, polyethylene, polypropylene, polystyrene, polyamide and polyimide films. Regardless of the material used for the first substrate 20, it may be preferred that the inventive gift wrap material is opaque, to prevent viewing of the target surface through the gift wrap material 10. Thus, the material selection for the first substrate 20 may be affected by the desire to select an opaque, or substantially opaque material.

The second substrate 30 illustrated in FIGS. 2, 2A, 3, 4 and 4A, is preferably formed from plastics such as polypropylene, polyethylene, polyvinyl chloride, polyvinylidine chloride, cellulose esters, cellulose ethers, polyester, polyurethane, polyacrylate, polyamide, or polyimide, although it is understood that other materials may be used for the second substrate 30 without departing from the spirit and scope of the disclosure. Again, the desire for a substantial level of opacity of the gift wrap can affect the selection of material for the second substrate 30.

The material used for the first substrate 20 in the embodiment illustrated in FIG. 3A may include plastics such as polypropylene, polyethylene, polyvinyl chloride, polyvinylidine chloride, cellulose esters, cellulose ethers, polyester, polyurethane, polyacrylate, polyamide, and polyimide, in addition to paper saturated with such materials. It may be desirable to select a material that is deformable in order to create standoffs, while still providing high aesthetic value. Properties that affect aesthetic value include the ability to receive printing on the decorative side of the substrate, the ability to receive shining metallic coatings such as by vapor coating, and the ability of the substrate to resist puncture or tearing.

Adhesives useful in the current inventive embodiments include pressure sensitive adhesives. Pressure sensitive adhesives useful in the present invention include, for example, those based on natural rubbers, synthetic rubbers, styrene block copolymers, polyvinyl ethers, poly (meth)acrylates (including both acrylates and methacrylates), polyolefins, and silicones, acrylic polymers and copolymers, or styrene butadiene copolymers.

While the list above suggests useful pressure sensitive adhesives for the invention, any suitable pressure sensitive adhesive composition can be used for the present invention. The pressure sensitive adhesive component can be any material that has pressure sensitive adhesive properties. Furthermore, the pressure sensitive adhesive component can be a single pressure sensitive adhesive or the pressure sensitive adhesive can be a combination of two or more pressure sensitive adhesives.

Pressure sensitive adhesives are generally characterized by their properties. Pressure sensitive adhesives are well known to one of ordinary skill in the art to possess properties including the following: (1) aggressive and permanent tack, (2) adherence to a substrate with no more than finger pressure, (3) sufficient ability to hold onto an adherend, and (4) sufficient cohesive strength to be removed cleanly from the adherend. Many pressure sensitive adhesives must satisfy these properties under an array of different stress rate conditions. Additives may be included in the pressure sensitive adhesive to optimize the characteristics of the pressure sensitive adhesive.

The pressure sensitive adhesive may be inherently tacky. If desired, tackifiers may be added to a base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, and curing agents. In certain embodiments, for example embodiments with lower flow or creep, the pressure sensitive adhesive matrix has an inherent viscosity of at least about 0.45 dl/g. The inherent viscosity is measured on a solution of the adhesive in a solvent at 25° C. The difference in out-flow time between the polymer solution and solvent is measured using a Schott Gerate capillary viscometer to find the relative viscosity. For example, for acrylic adhesives, the solvent is ethyl acetate and the polymer is at a concentration of 0.1 g/dL. The inherent viscosity is then calculated as the natural log of the relative viscosity over the concentration.

Adhesives suitable for use in the current inventive embodiments may be applied to the substrate in the form of aqueous dispersions, dispersions or solutions in organic solvent, or as hot melt coatings. Preferred adhesives include repositionable adhesives such as microsphere adhesives of particle size from 5 to 100 microns in diameter.

The selective adhesion mechanism of the gift wrapping material is intended to allow the material to be stored in roll form, prior to use, without the need for a release liner covering the selective adhesion mechanism. Provided that the winding tension of the roll is at a level below the level that activates the selective adhesion mechanism, the gift wrapping material may be stored as a freely unwinding roll. Preferably, when in roll form, the gift wrapping material is wound at a tension that is less than 50 percent of the tension that is sufficient to cause activation of the selective adhesion mechanism. It may, nevertheless, be desirable to apply a release coating to the decorative surface of the gift wrapping material to control the level of adhesion that may occur during inadvertent mishandling of the roll leading to activation of the selective adhesion mechanism in some areas. Suitable release coatings, sometimes known as Low Adhesion Backsizes (LAB's), are well known and may include hydrocarbon wax derivatives, fatty acid derivatives, polydialkylsiloxanes and fluorocarbon compounds.

Although the present invention has been described with reference to various embodiments, workers skilled in the art will recognize that changes may be made in form and detail without departing from the spirit and scope of the invention.

1. A gift wrap material affixable to a target surface comprising:
a linerless opaque first substrate and having a first major surface and a second major surface and a second substrate secured to the first substrate;
a selective adhesion mechanism disposed substantially continuously on the first major surface, the selective adhesion mechanism including a plurality of discrete standoffs formed in to the second substrate in a substantially amorphous pattern and extending outwardly from the first substrate and repositionable pressure sensitive adhesive disposed between and completely surrounding the standoffs at an average thickness less than the height of the standoffs prior to activation;
wherein the selective adhesion mechanism is configured so as to provide a first adhesion force to discrete regions of the target surface before activation of the mechanism and a second adhesion force of at least about 20 grams per centimeter width to the substrate after activation of the mechanism;
wherein the first adhesion force is at a level so as to allow the sheet to be positionable on the target surface;
wherein the selective adhesion mechanism is configured so as to be activatable by a force of at least about 20,000 N/m² (Pa) applied in a direction generally normal to the plane of the first substrate

2. The gift wrap material of claim 1, wherein the second adhesion force is less than about 100 grams per centimeter width.

3. The gift wrap material of claim 1, wherein the first adhesion force is no greater than about two grams per centimeter width.

4. The gift wrap material of claim 1, wherein the first substrate is plastic.

5. The gift wrap material of claim 1, wherein the first substrate is paper.

6. The gift wrap material of claim 1 and further comprising:
indicia disposed on the second major surface.
